(19) United States
(12) Patent Application Publication
(10) Pub. No.: US 2022/0179915 A1
(43) Pub. Date: Jun. 9, 2022

(54) ORDER PRESERVING PATTERN MATCHING APPARATUS, ORDER PRESERVING PATTERN MATCHING METHOD, AND COMPUTER-READABLE MEDIUM STORING PROGRAM

(71) Applicant: NEC corporation, Minato-ku, Tokyo (JP)

(72) Inventors: Yoichi SASAKI, Tokyo (JP); Shiho SUGIMOTO, Tokyo (JP)

(73) Assignee: NEC corporation, Minato-ku, Tokyo (JP)

(21) Appl. No.: 17/603,649

(22) PCT Filed: Apr. 19, 2019
(86) PCT No.: PCT/JP2019/016868

§ 371 Date: Oct. 14, 2021

(51) Int. Cl. G06F 16/903; G06F 16/31; G06F 16/338

(52) U.S. Cl. CPC G06F 16/90344; G06F 16/338; G06F 16/313

(57) ABSTRACT

An order preserving pattern matching apparatus according to the present disclosure includes: a pattern conversion unit configured to convert a retrieval pattern composed of text data arranged two-dimensionally to a matching pattern composed of the text data arranged one-dimensionally; a character string matching and indexing unit configured to generate an index for specifying a part of a pattern to be retrieved which matches the matching pattern in an order preserving manner as index information; a matching unit configured to assign a prescribed ID number to a part of the two-dimensional pattern to be searched composed of text data arranged two-dimensionally and including an array larger than that of the retrieval pattern; and an output unit configured to output a part of the two-dimensional pattern to be searched to which the prescribed ID number is assigned by the matching unit as a matching position.

### TECHNICAL FIELD

The present disclosure relates to an order preserving pattern matching apparatus, an order preserving pattern matching method, and a computer-readable medium storing a program, in particular, to an order preserving pattern matching apparatus, an order preserving pattern matching method, and a computer-readable medium storing a program for solving the Order Preserving Pattern Matching problem of specifying whether or not the sequence of characters in a character string matches magnitude relations of values of the characters.

### BACKGROUND ART

In recent years, there has been a growing demand for processing big data such as map data, image data, and POS data such as purchase history. In processing these big data, features being sought are extracted from the data. Many such data mining techniques for finding features of data have been proposed. These data mining techniques can be grouped into techniques for solving the Pattern Matching (PM) problem of specifying a part of a text that fully matches a pattern and the Order Preserving Pattern Matching (OPPM) problem of specifying a part of a text that has a sequence of characters in a character string which matches the magnitude relations of the values of the characters.

Techniques for solving the Order Preserving Pattern Matching problem as regards one-dimensional data are disclosed in, for instance, NPLs 1 and 2. Further, techniques for solving the Pattern Matching problem as regards two-dimensional data are disclosed in, for instance, NPLs 3 and 4.

### CITATION LIST

### Non-Patent Literature

NPL 1: Kim, J., Eades, P., Fleischer, R., Hong, S., Iliopoulos, C. SW., Park, K
NPL 2: M. Kubica, T. Kulczynski, J. Radoszewski, W. Rytter, and T. Walen.: A linear time algorithm for consecutive permutation pattern matching. Inf. Process. Lett., 113(12):430-433, 2013.
NPL 3: T. P. Baker.: A technique for extending rapid exact-match string-matching to arrays of more than one dimensions, SIAM J. Comput. 7, 1978.
NPL 4: R. S. Bird: Two-dimensional pattern-matching, Info. Proc. Lett. 6, 1977

### SUMMARY OF INVENTION

### Technical Problem

However, in the aforementioned proposed techniques, there is a problem that the Order Preserving Pattern Matching problem as regards two-dimensional data cannot be solved.

### Solution to Problem

An order preserving pattern matching apparatus according to an aspect of the present disclosure includes:

a pattern conversion unit configured to convert a retrieval pattern composed of text data arranged two-dimensionally to a matching pattern composed of the text data arranged one-dimensionally;

an index generating processing for character string matching unit configured to generate an index for specifying a part of a pattern to be retrieved which matches the matching pattern in an order preserving manner as index information;

a matching unit configured to assign a prescribed ID number to a part of a two-dimensional pattern to be searched composed of text data arranged two-dimensionally and including an array larger than that of the retrieval pattern; and

an output unit configured to output the part of the two-dimensional pattern to be searched to which the prescribed ID number is assigned by the matching unit as a matching position.

An order preserving pattern matching method according to an aspect of the present disclosure is an order preserving pattern matching method of searching a two-dimensional pattern to be searched stored in a database and composed of text data arranged two-dimensionally for a part thereof that matches an order preserving pattern that matches a retrieval pattern composed of text data arranged two-dimensionally, the order preserving pattern matching method including:

converting the retrieval pattern to a matching pattern composed of text data arranged one-dimensionally;

generating an index for specifying a part of a pattern to be retrieved which matches the matching pattern in an order preserving manner as index information;

assigning a prescribed ID number to a part of the two-dimensional pattern to be searched which matches the matching pattern using the index information; and

outputting the part of the two-dimensional pattern to be searched to which the prescribed ID number is assigned as a matching position.

A computer-readable medium according to an aspect of the present disclosure is a computer-readable medium storing an order preserving pattern matching program for causing a computer to perform an order preserving pattern matching process of searching a two-dimensional pattern to be searched that is stored in a database and composed of text data arranged two-dimensionally for a part thereof that matches an order preserving pattern that matches a retrieval pattern composed text data arranged two-dimensionally, the order preserving pattern matching program causing the computer to perform:

pattern conversion processing of converting a retrieval pattern composed of text data arranged two-dimensionally to a matching pattern composed of the text data arranged one-dimensionally;

index generating processing for character string matching processing of generating an index for specifying a part of a pattern to be retrieved which matches the matching pattern in an order preserving manner as index information;

matching processing of assigning a prescribed ID number to a part of the two-dimensional pattern to be searched composed of text data arranged two-dimensionally and including an array larger than that of the retrieval pattern using the index information; and

output processing of outputting the part of the two-dimensional pattern to be searched to which the prescribed ID number is assigned in the matching processing as a matching position.

### Advantageous Effects of Invention

According to an order preserving pattern matching apparatus, an order preserving pattern matching method, and a computer-readable medium storing a program, the Order Preserving Pattern Matching problem as regards two-dimensional data can be solved.

### BRIEF DESCRIPTION OF DRAWINGS

FIG. 1 is a diagram for explaining the challenges related to the Order Preserving Pattern Matching problem as regards two-dimensional data;

FIG. 2 is a block diagram illustrating a configuration of an order preserving pattern matching apparatus according to a first example embodiment;

FIG. 3 is a diagram schematically illustrating the operations of a pattern conversion unit and an index generation unit for character string matching of the order preserving pattern matching apparatus according to the first example embodiment;

FIG. 4 is a diagram specifically illustrating the operations of the pattern conversion unit and the index generation unit for character string matching of the order preserving pattern matching apparatus according to the first example embodiment; and

FIG. 5 is a diagram illustrating the operations of a matching unit of the order preserving pattern matching apparatus according to the first example embodiment.

### DESCRIPTION OF EMBODIMENTS

### First Example Embodiment

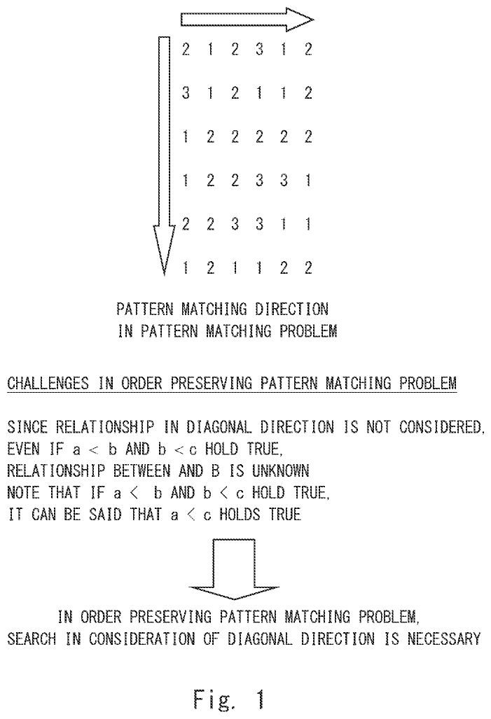

Hereinbelow, example embodiments of the present disclosure will be described with reference to the drawings. First, the Order Preserving Pattern Matching problem as regards a two-dimensional pattern to be processed by an order preserving pattern matching apparatus 1 according to a first example embodiment will be explained. A diagram for explaining the challenges related to the Order Preserving Pattern Matching problem as regards two-dimensional data is shown in FIG. 1.

In FIG. 1, the top diagram shows the matching direction of data in the Pattern Matching problem as regards two-dimensional data indicated in the aforementioned NPLs 3 and 4. As shown in the top diagram of FIG. 1, in the Pattern Matching problem as regards two-dimensional data, that is, the Pattern Matching problem as regards data arranged two-dimensionally, a retrieval pattern can be searched when the data matches the matching pattern in the two directions of the horizontal direction (e.g., the x-direction) and the vertical direction (e.g., the Y-direction). This is because in the Pattern Matching problem, the relationship with a=c is compensated if a=b and b=c hold true, whereby the pattern does not need to be searched in the diagonal direction thereof.

The bottom diagram of FIG. 1 shows the challenges concerning the Order Preserving Pattern Matching problem as regards two-dimensional data. In the Order Preserving Pattern Matching problem as regards two-dimensional data, unlike in the Pattern Matching problem, the target of retrieval is the magnitude relations of the values of the characters in the arranged character string. Therefore, a problem arises when the pattern is searched without considering the relationship among the characters in the diagonal direction of the pattern. Specifically, when the pattern is not searched in the diagonal direction thereof, there is a problem that the magnitude relation of a and b is unknown even if a<c and b<c hold true. On the other hand, the relationship of a<c is compensated if a<b and b<c holds true. As described above, in the Order Preserving Pattern Matching problem as regards two-dimensional data, there is a problem that it is not possible to compensate whether the pattern to be retrieved matches the search pattern unless the pattern to be retrieved is searched for a part thereof in the diagonal direction that matches the search pattern.

In the order preserving pattern matching apparatus 1 according to the first example embodiment described below, a matching pattern composed of text data arranged one-dimensionally (hereinafter referred to as the one-dimensional pattern M) is generated from the retrieval data in which text data is arranged two-dimensionally (e.g., m-rows by m-columns). Then, the order preserving pattern matching apparatus 1 according to the first example embodiment generates index information S regarding the one-dimensional pattern M. Further, in the order preserving pattern matching apparatus 1 according to the first example embodiment, as regards the two-dimensional pattern to be searched T composed of text data arranged two-dimensionally (e.g., n-rows by n-columns), a part thereof in which the retrieval pattern P and the order preserving pattern match each other is specified using the index information S. As described above, by converting the retrieval pattern P to the one-dimensional pattern M and applying the index information S generated based on the one-dimensional pattern M to the two-dimensional pattern to be searched T, matching of the order preserving pattern in the diagonal direction of the pattern can be compensated. Note that in the example described below, the order preserving pattern matching apparatus 1 according to the first example embodiment sets a region to be searched of n-rows by m-columns in the two-dimensional pattern to be searched T, and by shifting the instant region to be searched in the column direction, the two-dimensional pattern to be searched T is searched for the part thereof that matches the one-dimensional pattern M.

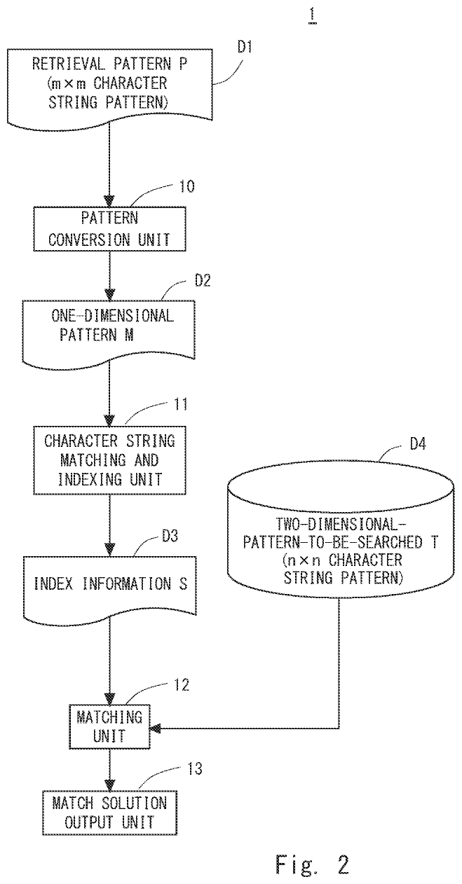

Now, a block diagram illustrating a configuration of the order preserving pattern matching apparatus 1 according to the first example embodiment is shown in FIG. 2. Note that in the configuration shown in FIG. 2, each processing performed by the order preserving pattern matching apparatus 1 is represented by a block, and the content of the processing represented by each block can be realized by an exclusive hardware, a software implemented by a computer, or the like. In the following description, an example in which the processing is performed by a software implemented by a computer will be described.

The order preserving pattern matching apparatus 1 according to the first example embodiment loads the retrieval pattern P as a file D1 and the two-dimensional pattern to be searched T stored in a two-dimensional-pattern-to-be-searched database D4 is searched for the part thereof that matches the retrieval pattern P. Here, in the order preserving pattern matching apparatus 1 according to the first example embodiment, both the retrieval pattern P and the two-dimensional pattern to be searched T are composed of text data arranged two-dimensionally. Further, the two-dimensional pattern to be searched T includes a two-dimensional array pattern that is larger than the retrieval pattern P. When the pattern size of the retrieval pattern P is m×m and the pattern size of the two-dimensional pattern to be searched T is n×n, the relationship of m<n holds true.

As shown in FIG. 2, the order preserving pattern matching apparatus 1 according to the first example embodiment includes, as processing blocks, a pattern conversion unit 10, an index generation unit for character string matching 11, a matching unit 12, and an output unit (e.g., a match solution output unit 13).

The pattern conversion unit 10 converts the retrieval pattern P to the one-dimensional pattern M composed of text data arranged one-dimensionally. The pattern conversion unit 10 outputs the one-dimensional pattern M as a file D2. The index generation unit for character string matching 11 generates an index for specifying the pattern to be retrieved which matches the one-dimensional pattern M in an order preserving manner as the index information S. The index generation unit for character string matching 11 outputs the index information S as a file D3. The matching unit 12 is configured to assign a prescribed ID number to the part of the two-dimensional pattern to be searched T composed of the text data arranged two-dimensionally which matches the matching pattern using the index information S. The match solution output unit 13 outputs the part of the two-dimensional pattern to be searched T to which the prescribed ID number has been assigned by the matching unit 12 as a matching position.

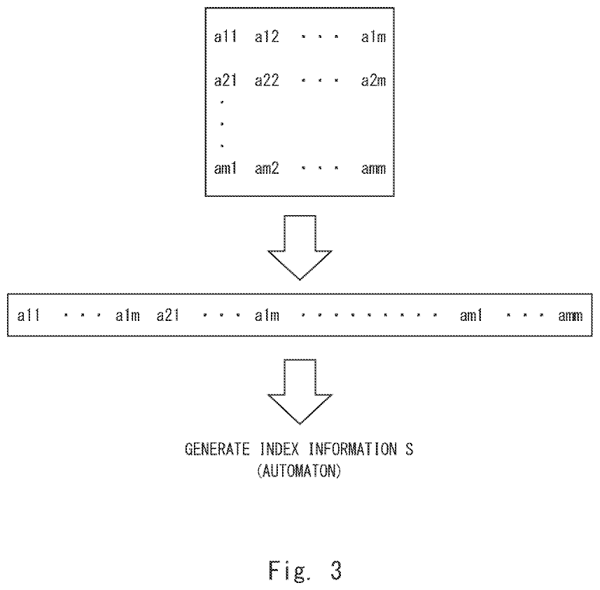

Here, among the processing blocks of the order preserving pattern matching apparatus 1, operations of the pattern conversion block 10 and the index generation unit for character string matching 11 will be described in detail. A diagram for schematically explaining the operations of the pattern conversion unit 10 and the index generation unit for character string matching 11 of the order preserving pattern matching apparatus 1 according to the first example embodiment is shown in FIG. 3. In the example shown in FIG. 3, a one-dimensional pattern M is generated for the retrieval pattern P of m-rows by m-columns.

As shown in FIG. 3, the pattern conversion unit 10 splits the retrieval pattern P by rows and the split rows are arranged one-dimensionally in the order of the respective rows to thereby generate the one-dimensional pattern M. Then, the index generation unit for character string matching 11 generates the index information S for the one-dimensional pattern M. Here, in the order preserving pattern matching apparatus 1 according to the first example embodiment, an automaton is generated as the index information S. The generated automaton is an index of character string that is built such that the acceptance states indicating the magnitude relation of the consecutive values are chained.

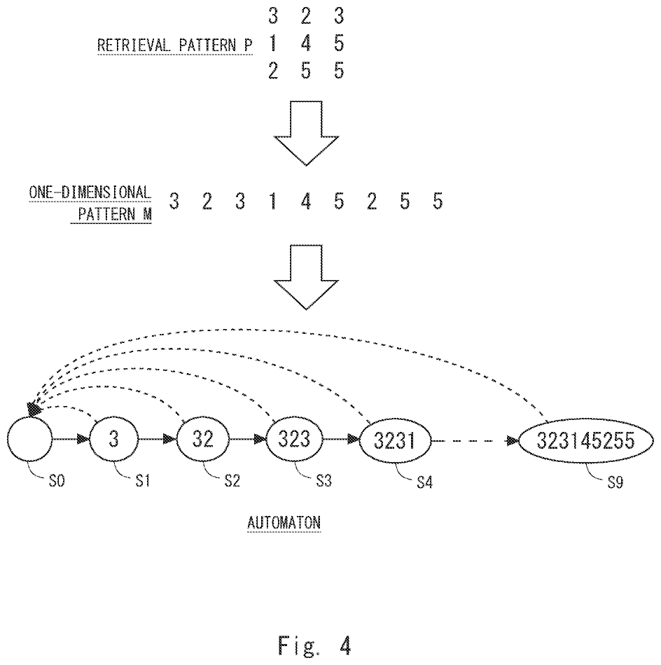

Further, the processing shown in FIG. 3 is explained with reference to examples giving specific numerical values. A diagram for specifically explaining the operations of the pattern conversion unit and the index generation unit for character string matching of the order preserving pattern matching apparatus according to the first example embodiment is shown in FIG. 4. In the example shown in FIG. 4, nine numerical values are arrayed in 3-rows by 3-columns as the retrieval pattern P. The pattern conversion unit 10 splits the retrieval pattern P by rows and the rows split by the order of the respective rows are arrayed one-dimensionally. In the example shown in FIG. 4, in the one-dimensional pattern M, following values 323 in the first row of the retrieval pattern P, values 145 in the second row of the retrieval pattern P are arrayed, followed by the values 255 in the first row of the retrieval pattern P.

Then, as shown in FIG. 4, the acceptance state of each automaton generated by the index generation unit for character string matching 11 is chained to each other so that when the magnitude of relationship between the last numerical values of the consecutive numerical values and the last-but-one numerical values of the consecutive values matches the sequence to be compared, the acceptance state transits to the next acceptance state. Further, the acceptance state of each automaton shown in FIG. 4 returns to the first acceptance state S0 when the magnitude of relation between the last numerical values and the last-but-one numerical values does not match the sequence to be compared.

Next, the matching unit 12 will be described. The matching unit 12 reads-out the two-dimensional pattern to be searched T from the two-dimensional-pattern-to-be-searched database D4 and performs search of the two-dimensional pattern to be searched T that has been read-out using the index information S generated as the file D3. The matching unit 12 assigns a prescribed ID number to the part of the two-dimensional pattern to be searched T which matches the matching pattern P using the index information S. Further, in the order preserving pattern matching apparatus 1 according to the first example embodiment, as aspect of a method of matching by the matching unit 12, the following operations are performed. The matching unit 12 according to the first example embodiment sets a region to be searched composed of the number of rows corresponding to the number of characters in the row direction of the retrieval pattern P and the number of columns corresponding to the number of the characters in the column direction of the two-dimensional pattern to be searched T from the text data included in the two-dimensional pattern to be searched T. Then, the matching unit 12 according to the first example embodiment, and by shifting the region to be searched in the column direction, the two-dimensional pattern to be searched T is searched for the part thereof that matches the matching pattern P.

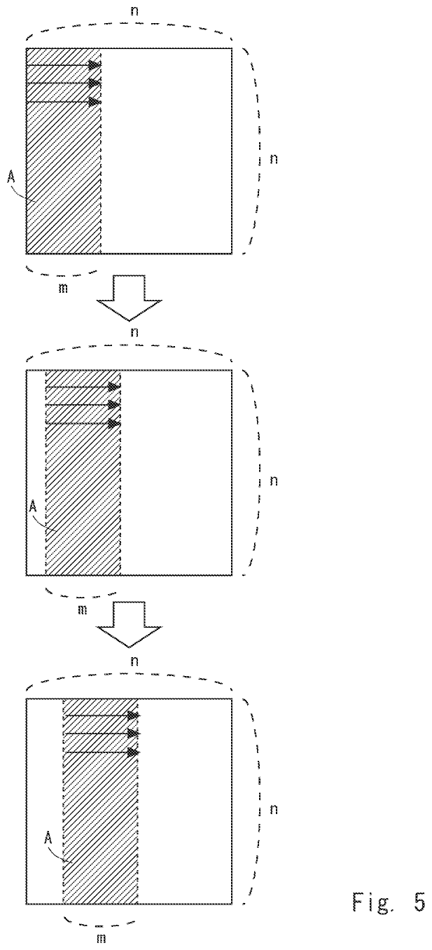

The operations of the matching unit 12 of the order preserving pattern matching apparatus 1 according to the first example embodiment is shown in FIG. 5. In the example shown in FIG. 5, the two-dimensional pattern to be searched T of n-rows by n-columns is searched for the retrieval pattern P of m-rows by m-columns. As shown in FIG. 5, the matching unit 12 sets the region to be searched A composed of columns corresponding to the number of columns of the retrieval pattern P (e.g., n columns) and rows corresponding to the number of rows of the two-dimensional pattern to be searched T (e.g., n rows) in the two-dimensional pattern to be searched T. Then, using the text at the beginning of the line in the region to be searched A as a search start character, search is performed using the index information S. The matching unit 12 performs search using the index information S by shifting the rows of the region to be searched A sequentially and setting the leading character of each row as a search start character. Further, the matching unit 12 performs search using the index information S while sequentially shifting the region to be set as the region to be searched A in the column direction. Then, the matching unit 12 assigns the prescribed ID number set in advance to the leading character when the matching has been completed up to the final reception state of the index information S (e.g., the reception state S9 in FIG. 4). On the other hand, when the final reception state of the index information S is not reached, the matching unit 12 replaces the leading character of the matching cycle to an ID number (e.g., 0) indicating that there is no matched pattern.

Then, the match solution output unit 13 outputs the part of the pattern to which the ID number has been assigned by the matching unit 12 as the matching position.

According to the aforementioned description, the order preserving pattern matching apparatus 1 according to the first example embodiment converts the retrieval pattern P composed of a two-dimensional array to the one-dimensional pattern M composed of a one-dimensional array. Then, the index information S is generated based on the one-dimensional pattern M and search is performed for the two-dimensional pattern T to be searched T using the instant index information S. By this configuration, the order preserving pattern matching apparatus 1 can perform the search related to the various directions of the retrieval pattern P through the series of matching processing performed by the matching unit 12. Further, the order preserving pattern matching apparatus 1 can make the each number of the matching pattern to be generated (for instance, the one-dimensional pattern M) and the index information S to be one.

By this configuration, the order preserving pattern matching apparatus 1 according to the first example embodiment can search the two-dimensional pattern to be searched T for a pattern that matches the retrieval pattern P in an order preserving manner from among the two-dimensional pattern to be searched T by performing a small number of computations. For instance, by employing the order preserving pattern matching apparatus 1 according to the first example embodiment, the number of computations O can be O (mn 2).

Note that the present disclosure is not limited to the example embodiments described above can be modified as appropriate without departing from the gist of the present disclosure.

In the examples described above the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers or a wireless communication line.

### REFERENCE SIGNS LIST

1 ORDER PRESERVING PATTERN MATCHING APPARATUS
10 PATTERN CONVERSION UNIT
11 INDEX GENERATION UNIT FOR CHARACTER STRING MATCHING
12 MATCHING UNIT
13 MATCH SOLUTION OUTPUT UNIT
P RETRIEVAL PATTERN
T TWO-DIMENSIONAL PATTERN TO BE SEARCHED
M ONE-DIMENSIONAL PATTERN
S INDEX INFORMATION
D1 FILE
D2 FILE
D3 FILE
D4 TWO-DIMENSIONAL-PATTERN-TO-BE-SEARCHED DATABASE
A REGION TO BE SEARCHED

What is claimed is:

1. An order preserving pattern matching apparatus comprising:
a pattern conversion unit configured to convert a retrieval pattern composed of text data arranged two-dimensionally to a matching pattern composed of the text data arranged one-dimensionally;
an index generation unit for character string matching configured to generate an index for specifying a part of a pattern to be retrieved which matches the matching pattern in an order preserving manner as index information;
a matching unit configured to assign a prescribed ID number to a part of a two-dimensional pattern to be searched composed of text data arranged two-dimensionally and including an array larger than that of the retrieval pattern; and
an output unit configured to output the part of the two-dimensional pattern to be searched to which the prescribed ID number is assigned by the matching unit as a matching position.

2. The order preserving pattern matching apparatus according to claim 1, wherein the pattern conversion unit is configured to split the retrieval pattern by rows and text data included in the split rows are arrayed in the order of the respective rows to thereby generate the matching pattern.

3. The order preserving pattern matching apparatus according to claim 1, wherein the matching unit sets a region to be searched composed of the number of columns corresponding to the number of characters in the column direction of the retrieval pattern and the number of rows corresponding to the number of the characters in the row direction of the two-dimensional pattern to be searched from the text data included in the two-dimensional pattern to be searched, and by shifting the instant region to be searched in the column direction, the part of the two-dimensional pattern to be searched is searched for the part thereof that matches the matching pattern.

4. The order preserving pattern matching apparatus according to claim 1, wherein the index information is an automaton in which reception states indicating a magnitude relation of consecutive values are chained.

5. An order preserving pattern matching method of searching a two-dimensional pattern to be searched stored in a database and composed of text data arranged two-dimensionally for a part thereof that matches an order preserving pattern that matches a retrieval pattern composed of text data arranged two-dimensionally, the order preserving pattern matching method comprising:
converting the retrieval pattern to a matching pattern composed of text data arranged one-dimensionally;
generating an index for specifying a part of a pattern to be retrieved which matches the matching pattern in an order preserving manner as index information;
assigning a prescribed ID number to a part of the two-dimensional pattern to be searched which matches the matching pattern using the index information; and
outputting the part of the two-dimensional pattern to be searched to which the prescribed ID number is assigned as a matching position.

6. A computer-readable medium storing an order preserving pattern matching program for causing a computer to perform an order preserving pattern matching process of searching a two-dimensional pattern to be searched that is stored in a database and composed of text data arranged two-dimensionally for a part thereof that matches an order preserving pattern that matches a retrieval pattern composed of text data arranged two-dimensionally, the order preserving pattern matching program causing the computer to perform:
pattern conversion processing of converting a retrieval pattern composed of text data arranged two-dimensionally to a matching pattern composed of the text data arranged one-dimensionally;
index generating processing for character string matching of generating an index for specifying a part of a pattern to be retrieved which matches the matching pattern in an order preserving manner as index information;
matching processing of assigning a prescribed ID number to a part of the two-dimensional pattern to be searched composed of text data arranged two-dimensionally and including an array larger than that of the retrieval pattern using the index information; and
output processing of outputting the part of the two-dimensional pattern to be searched to which the prescribed ID number is assigned in the matching processing as a matching position.
